(19) United States
(12) Patent Application Publication
(10) Pub. No.: US 2002/0041176 A1
(43) Pub. Date: Apr. 11, 2002

(54) Battery apparatus for charging portable device

(76) Inventor: Yutaka Eki, Tsurugashima-shi (JP)

Correspondence Address: Pillsbury Winthrop LLP, Ninth Floor, East Tower, 1100 New York Avenue, Washington, DC, 20005-3918, US

(21) Appl. No.: 09/961,410

(22) Filed: Sep. 25, 2001

(30) Foreign Application Priority Data
Sep. 29, 2000 (JP) 2000-299061

(51) Int. Cl. H02J 7/00

(52) U.S. Cl. 320/109

(57) ABSTRACT

A battery apparatus for charging a portable device, including: a first coil which a current is supplied to, the first coil being mounted in a first case; and a second coil, which power from the first coil is transmitted to, the second coil being mounted in a second case; the second coil comprising an air-core coil, the inside diameter of the winding of the air-core coil being greater than the inside diameter of the winding of the first coil, and the first coil and second coil being arranged so that winding faces thereof are opposite each other.

### BACKGROUND OF THE INVENTION

1. Field of the Invention

The present invention relates to a battery apparatus for charging a non-contact portable device used in portable devices such as cordless telephones, mobile telephones, and PHS.

2. Related Art

A battery apparatus for charging a non-contact portable device comprises a primary circuit on the charging side and a secondary circuit on the charged side, these being mounted inside cases in complete isolation from each other. Current is supplied from a power source, and generates magnetic flux in the coil of the primary side circuit; the magnetic flux of the coil of the primary side circuit generates induced electromotive force in the coil of the secondary side circuit on the charged side. The induced electromotive force is rectified, and used to recharge a secondary battery (battery for charging) in a mobile telephone or the like. In this type of battery apparatus for charging a non-contact portable device, in order to efficiently transmit power from the charging side to the charged side, it is important that the coil of the primary circuit and the coil of the secondary circuit are Lightly coupled, so that the magnetic flux does not leak. A conventional method for reducing leakage of magnetic flux is to arrange the coils of the primary side and secondary side circuits with their winding faces opposite each other on their core axes, and to make their cases extremely thin, so as to reduce the size of the gap between them.

One example of a recent battery apparatus for charging non-contact portable devices, which has been made small, thin, and light, and is used in comparatively small-capacity charging, will be explained based on FIG. 4A. Reference numeral 50 represents a resin case which accommodates a charging side primary circuit, and reference numeral 55 represents a resin case which accommodates a secondary side circuit comprising the main body of a portable device.

The coil L11 of the primary side circuit comprises a winding 53, wound around a coil form comprising a resin bobbin 52 which a T-shaped magnetic core 51 is inserted through. The lead wire of the winding 53 connects to a terminal 54, which is provided on the bottom face of the bobbin 52 and is connected to an outside circuit.

The coil L12 of the secondary side circuit comprises a winding 57, wound around a coil form comprising a resin bobbin 56.

The outsides of the winding coil for of the bobbin 52 of the coil L11 of the primary side circuit and the bobbin 56 of the coil L12 of the secondary side circuit are the same size, and the winding faces of the two coils are facing each other with the cases therebetween.

In order to lighten the main body of the portable device and reduce cost, the above battery apparatus for charging a portable device does not have a magnetic core in the coil L12 of the secondary side circuit. In order to reduce the distance between the coil L11 of the primary side circuit and the coil L12 of the secondary side circuit, the winding faces directly contact the faces of the cases. Since bobbins are used as the coil forms, the winding diameters of the two coils are conventionally made approximately the same.

However, as shown by the dotted lines in FIG. 4B, the distribution of the magnetic flux, which is emitted by the coil L11 of the primary side circuit, is not linear, but forms a loop from the protruding section of the magnetic core 51, around the winding 53, to the bottom edge face of the magnetic core 51. At the region (gap G) where the coil L12 of the secondary side circuit is positioned between the case 50 of the primary side circuit and the case 55 of the secondary side circuit in the magnetic flux emitted by the coil L11 of the primary side circuit, the fact that the winding inside diameter X or the coil L11 of the primary side circuit is approximately the same as the winding inside diameter Y of the coil L12 or the secondary side circuit makes it difficult for the coil L12 of the secondary side circuit to efficiently collect the magnetic flux emitted from the coil L11 of the primary side circuit. Consequently, in order to efficiently transmit the necessary power to the coil L12 of the secondary side circuit, measures must be taken such as increasing the number of windings in the coils of the primary side and secondary side circuits, or increasing the area of their opposing sections. Such measures have a disadvantage of making the circuits larger.

### SUMMARY OF THE INVENTION

The present invention has been realized in order to solve problems such as those mentioned above. After considering the relationship between the distance between the opposing coils and the inside diameters of the coils, the inventors have discovered that, by securing a predetermined relationship, the magnetic flux generated by the coil of the primary side circuit can be efficiently transmitted to the coil of the secondary side circuit. It is an object of this invention to provide a thin, lightweight, and inexpensive battery apparatus for charging a portable device which efficiently utilizes this discovery.

In order to achieve the above object, the battery apparatus for charging a portable device according to the present invention comprises a first coil which a current is supplied to, the first coil being mounted in a first case; and a second coil, which power from the first coil is transmitted to, the second coil being mounted in a second case. The second coil comprises an air-core coil, the inside diameter of the winding of the air-core coil being greater than the inside diameter of the winding of the first coil. The first coil and second coil are arranged so that their winding faces are opposite each other.

Furthermore, the first coil and the second coil comprise air-core coils which are made by self-bonding, such as cement wire (Trade mark). This enables the apparatus to be made thin and light.

### BRIEF DESCRIPTION OF THE DRAWINGS

FIGS. 1A and 1B show a cross-sectional view and magnetic flux distribution of a battery apparatus for charging a portable device according to a first embodiment of this invention;

FIGS. 2A and 2B show a cross-sectional view and magnetic flux distribution of a battery apparatus for charging a portable device according to a second embodiment of this invention;

FIG. 3 in a graph showing output characteristics of the battery apparatus for charging a portable device and a conventional battery apparatus for charging a portable device; and

FIGS. 4A and 4B show a cross-sectional view and magnetic flux distribution of one example of a conventional battery apparatus for charging a non-contact portable device.

### DESCRIPTION OF THE PREFERRED EMBODIMENTS

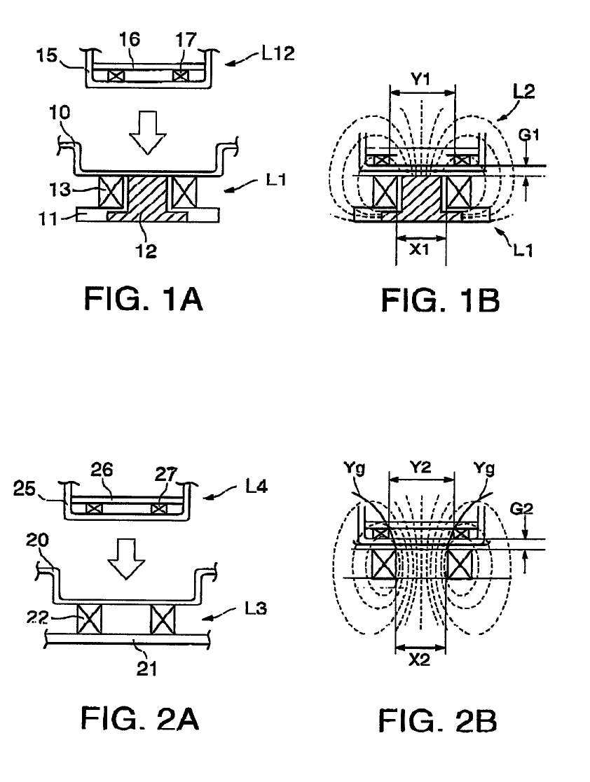

Preferred embodiments of the battery apparatus for charging a portable device according to the present invention will be explained with reference to FIGS. 1 to 3.

FIG. 1A is a cross-sectional view of a battery apparatus for charging a portable device according to a first embodiment of this invention, and FIG. 1B shows magnetic flux distribution of the same.

Reference numeral L1 represents a coil of the primary side circuit, and L2 represents a coil of the secondary side circuit The primary side circuit coil L1 comprises a T-shaped magnetic core 12, a winding 13, and a resin bobbin 11. The bobbin 11 has a bottom edge on a hollow cylindrical section, providing a winding groove. The bottom section of the cylindrical section of the bobbin 11 is larger than the top section, with the bottom edge as the boundary. The winding 13 is wound in the winding groove of the bobbin 11. The T-shaped magnetic core 12 comprises ferrite or the like, and has a protruding section at the top center of a plate-like section, thereby being T-shaped in cross-section. With the protruding section at the top, the T-shaped magnetic core 12 is inserted into the cylindrical section of the bobbin 11 from the bottom side, and the plate-like section is secured to the bottom face of the bottom edge so that the winding 13 is placed around the protruding section. The bobbin 11 is attached directly to an unillustrated circuit board.

The coil L2 of the secondary side circuit comprises an air-core coil 17, which a cement wire or the like is wound around and secured to, and the air-core coil 17 is attached by adhesive or the like at a predetermined position on a substrate 16.

The inside diameter Y1 of the air-core coil 17 is greater than the wind groove diameter X1 of the bobbin 11 of the coil L1 in the primary side circuit, the value of Y1 being determined in advance in accordance with the distance between the winding faces of the coil L1 of the primary side circuit and the coil L2 of the secondary side circuit.

The coil L1 of the primary side circuit and the coil L2 of the secondary side circuit are mounted respectively inside the case of a charger and the case or the main body of a portable device in such a manner that the winding face of the coil 13, which comprises the protruding section of the T-shaped magnetic core 11, faces towards the winding face of the air-core coil 17.

In FIG. 1B, the distribution of the magnetic flux generated by the coil L1 of the primary side circuit is shown by dotted lines. Reference numeral X1 represents the outer size of the bobbin coil form (i.e. the inside diameter of the winding 13) which the winding 13 is wound around the bobbin 11 of the coil L1 of the primary side circuit, Y1 represents the inside diameter of the air-core coil 17 of the coil L2 of the secondary side circuit, and G1 represents the gap between the coil L1 of the primary side circuit and the coil L2 of the secondary side circuit after incorporating the thickness of the case of the charging side and the thickness of the case on the charged side. When the winding face of the coil L2 of the secondary side circuit is positioned opposite the winding face of the coil L1 of the primary side circuit in the distribution of the magnetic flux generated by the coil L1 of the primary side circuit across the gap G1, by making the inside diameter Y1 of the air-core coil 17 greater than the inside diameter X1 of the winding 13, the coil L2 of the secondary side circuit can interlink with more magnetic flux than when the inside diameters are the same, enabling power to be more efficiently transmitted than in the conventional apparatus.

FIG. 2A shows a cross-sectional view and FIG. 2B shows magnetic flux distribution of a battery apparatus for charging a portable device according to a second embodiment of this invention which is adapted for low power, and can be made thin, lightweight, and inexpensive.

Reference numeral L3 represents a coil of the primary side circuit, and L4 represents a coil of the secondary side circuit. The coil L3 of the primary side circuit comprises an air-core coil 22, which a cement wire or the like is wound round at a predetermined number of windings and secured to, and the air-core coil 22 is attached by adhesive or the like to a circuit substrate 21. The coil L4 of the secondary side circuit comprises an air-core coil 27, which a cement wire or the like is wound round at a predetermined number of windings and secured to, and the air-core coil 27 is attached by adhesive or the like to a circuit substrate 26.

The inside diameter Y2 of the air-core coil 27 is greater than the wind groove diameter X2 of the air-core coil 22 in the primary side circuit, the value of Y2 being preset in accordance with the distance between the winding faces of the air-core coil 22 of the primary side circuit and the air-core coil 27 of the secondary side circuit.

The coil 63 of the primary side circuit and the coil L4 of the secondary side circuit are mounted respectively inside the case of a charger and the case of the main body of a small-scale portable device in such a manner that the winding faces of the air-core coils 22 and 27 face each other.

In FIG. 2B, the distribution of the magnetic flux generated by the coil L3 of the primary side circuit is shown by dotted lines. Reference numeral X2 represents the inside diameter of the air-core coil 22 of the coil L3 of the primary side circuit, Y2 represents the inside diameter of the air-core coil 27 of the coil L4 of the secondary side circuit, and G2 represents the gap between the coil L3 of the primary side circuit and the coil L4 of the secondary side circuit after incorporating the thickness of the case of the charging side and the thickness of the case on the charged side. When the winding face of the coil L4 of the secondary side circuit is positioned opposite the winding face of the coil L3 of the primary side circuit in the distribution of the magnetic flux generated by the coil L3 in the opened gap G2, by making the inside diameter Y2 of the air-core coil 27 greater than the inside diameter X2 of the air-core coil 22 of the primary side circuit, the coil L4 of the secondary side circuit can interlink with more magnetic flux than when the inside diameters are the same, enabling power to be more efficiently transmitted than in the conventional apparatus. As the interval (gap G2) between the coil L3 of the primary side circuit and the coil L4 of the secondary side circuit increases, the magnetic flux which is generated by the coil L3 of the primary side circuit can be more efficiently received by increasing the inside diameter of the air-core coil 27 of the secondary side circuit as shown by Yg, thereby increasing efficiency.

Incidentally, in the embodiment described above, due to the size of the charged device, the outside diameter of the winding of the coil in the secondary side circuit is substantially equal to the outside diameter of the winding of the coil in the primary side circuit.

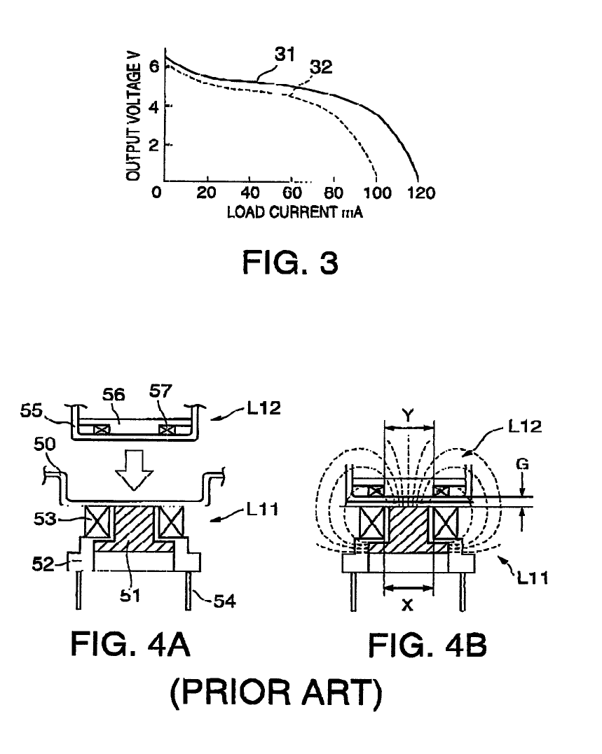

Subsequently, output characteristics of the battery apparatus for charging a portable device which uses the air-core coil of the second embodiment will be explained based on FIG. 3.

In FIG. 3 the vertical axis represents the voltage which is output to a load from the coil of the secondary side circuit, the horizontal axis represents current which is supplied to the load from the coil of the secondary side circuit, reference numeral 31 represents output characteristics of the battery apparatus for charging a portable device according to the present invention, wherein the inside diameter (18 mm in this embodiment) of the coil of the secondary side circuit has been increased, and reference numeral 32 represents output a characteristics of a conventional battery apparatus for charging a portable device, wherein the inside diameter (16 mm in this embodiment) of the coil of the secondary side circuit is the same as that of the coil of the primary side circuit. In both cases, the inside diameter of the coil of the primary side circuit is 16 mm, and the gap between the coil of the primary side circuit and the coil of the secondary side circuit is 4 mm.

Measurements obtained when a rectifier and a load ware connected to the coil of the secondary side confirm that the battery apparatus for charging a portable device according to the present invention obtained a greater load current and output voltage from the secondary side load than the conventional battery apparatus for charging a portable device, and the transmission efficiency was increased by approximately 12%.

The battery apparatus for charging a portable device according to the present invention is not limited to the embodiments described above. For example, the magnetic core which is used in the coil of the primary side circuit need not be cross-sectionally T-shaped, but may be cross-sectionally I-shaped or M-shaped; furthermore, the shape in the air-core coil when viewed from the winding face need not be circular, but may be multi-aided or any of various types of shape.

As described above, the battery apparatus for charging a portable device according to the present invention comprises an air-core coil as its second coil, the winding inside diameter of the second coil being greater than that or a first coil, and the first and second coils are arranged so that their winding faces are opposite each other. Therefore, magnetic flux which is generated by the winding of the first coil efficiently interlinks with the winding of the second coil.

Consequently, in the battery apparatus for charging a portable device according to the present invention, the magnetic flux generated by the winding of the first coil in the space between the opposing first and second coils can be efficiently interlinked with the second coil, whereby the transmission efficiency of power from the primary side circuit to the second side circuit can be increased.

Further, since the first coil and second coil of the battery apparatus for charging a portable device according to the present invention comprise air-core coils which do not use magnetic bodies, it is possible to provide the battery apparatus for charging a portable device which can be made thin and light, at low cot, in a small-scale portable device.

What is claimed is:

1. A battery apparatus for charging portable device, comprising:
a first coil which a current is supplied to, said fist coil being mounted in a first case; and a second coil, which power from said first coil is transmitted to, the second coil being mounted in a second case;
said second coil comprising an air-core coil, the inside diameter of the winding of said air-core coil being greater than the inside diameter of the winding of said first coil, and said first coil and second coil being arranged so that winding faces thereof are opposite each other.

2. The battery apparatus for charging a portable device according to claim 1, wherein the inside diameter of the winding of said second coil is greater than the inside diameter of the winding of said first coil, and the outside diameter of the winding of said second coil is substantially equal to the outside diameter of the winding of said first coil.

3. The battery apparatus for charging a portable device according to claim 1 or 2, wherein the inside diameter of the winding of said second coil is determined in consideration of the thickness of cases on the charging side and charged side and distribution of magnetic flux with respect to said first coil.

4. The batter apparatus for charging a portable device according to any one of claims 1 to 3, said first coil and said second coil comprise air-core coil; made from self-bonding wire.
